(19) United States
(12) Patent Application Publication
(10) Pub. No.: US 2004/0214466 A1
(43) Pub. Date: Oct. 28, 2004

(54) Joint connector of printed circuit board and manufacturing method thereof

(76) Inventor: Wen-Yen Lin, Taoyuan City (TW)

Correspondence Address: RABIN & BERDO, P.C., Suite 500, 1101 14 Street, N.W., Washington, DC, 20005, US

(21) Appl. No.: 10/817,803

(22) Filed: Apr. 6, 2004

(30) Foreign Application Priority Data
Apr. 25, 2003 (TW) 92109807

(51) Int. Cl. H01R 13/62

(52) U.S. Cl. 439/325

(57) ABSTRACT

A joint connector is provided to shorten the connection length of interface so as to improve the noises caused by the length. The joint connector has a plurality of slots and at least one electrical contact in each slot. When printed circuit boards are linked together, the corresponding electrical contacts of two printed circuit boards are bonded to each other to serve as a communication interface.

### BACKGROUND OF THE INVENTION

1. Field of Invention

The present invention relates to a joint connector for a board-to-board communication interface of printed circuit boards.

2. Description of Related Art

As the operation speed and the pin-count of an electronic component have been increased, it is difficult to control the quality of a signal. Thus, high density interconnect (hereafter HDI) printed circuit board has been developed for high-speed electronic components.

An electronic component or a normal printed circuit board can be electrically connected to another normal printed circuit board via a connector or a cable. However, a conventional connector or connection cable has a certain length for connection. FIG. 1 illustrates a conventional connection with connector and cable for board-to-board communication between printed circuit boards. At least 4 mm of connection cable 10 must be reserved for a connection interface. The longer the length of the connector or the connection cable is, the more noise the connector or the connection cable generates. Thus, there is a need to overcome the length bottleneck of the connector.

### SUMMARY OF THE INVENTION

It is therefore an objective of the present invention to provide a joint connector to shorten the connection length of interface so as to improve the noises caused by the signal through the interface.

In accordance with the foregoing and other objectives of the present invention, the joint connector includes a plurality of slots and at least one electrical contact in each slot. When printed circuit boards are connected, the electrical contacts of two printed circuit boards are bonded to each other so as to serve as a communication interface.

It is another objective of the present invention to provide a manufacturing method for the joint connector so as to integrate the same into normal PCB process.

In accordance with the foregoing another objective of the present invention, a manufacturing method for the joint connector includes forming a plurality of slots in connecting rims of a printed circuit board. Subsequently, a conductive layer is deposited in each slot, and an insulated gap is formed to divide the conductive layer into several electrical contacts.

According to one preferred embodiments of present invention, a plurality of slots of the joint connectors is formed by cutting or punching the connecting rims. A subsequent conductive layer is deposited in each slot by electroplating and is divided into more than two electrical contacts by removing a portion of the conductive layer by drilling, cutting or punching. The electrical contacts serve as a communication interface between printed circuited boards.

The present invention is directed to shortening the length of a connection interface so as to reduce noise in high-speed communication. High-speed components can be integrated into a small HDI board, rather than all components being integrated into a bigger HDI board. Thus, manufacturing cost can be reduced because an HDI board with small area is used. The joint connector can also replace the conventional connector in a low pin-count system.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a conventional connection with connector and cable for board-to-board communication of printed circuit boards;

FIG. 2 illustrates a perspective view of a joint connector according to one preferred embodiment of this invention;

FIG. 3 illustrates a perspective view of 2 PCB linked with a joint connector according to one preferred embodiment of this invention;

FIG. 4 illustrates a flowchart of manufacturing procedures for a joint connector according to one preferred embodiment of this invention;

FIG. 5 illustrates the first step of the manufacturing procedures of joint connector according to one preferred embodiment of this invention;

FIG. 6 illustrates the second step of the manufacturing procedures of joint connector according to one preferred embodiment of this invention; and

FIG. 7 illustrates the third step of the manufacturing procedures of joint connector according to one preferred embodiment of this invention.

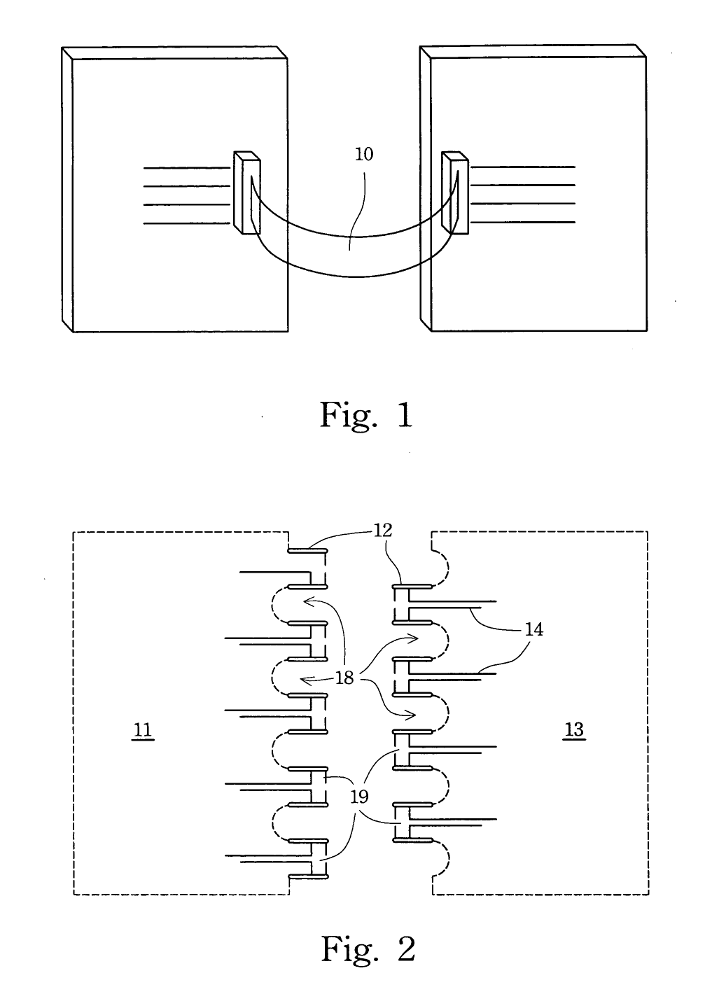

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to solve a bottleneck in prior art, the present invention provides a joint connector in connecting rims of the printed circuited boards (hereafter PCB). The joint connector consists of a plurality of slots with electrical contacts inside. When two connectors link together, the electrical contacts are employed to connect two printed circuited boards electrically. The joint connector can avoid noise caused by an impedance mismatch, a parasitic capacitance and a parasitic inductance.

FIG. 2 illustrates a perspective view of a joint connector according to one preferred embodiment of this invention. FIG. 2 consists of two PCBs and joint connectors thereof. PCB 11 and PCB 13 can be normal PCBs or HDI PCBs. The electrical contact 12 is a conductive layer deposited by electroplating. Each electrical contact 12 can be electrically connected to its destination according to demand. For example, each electrical contact 12 can be electrically connected to a corresponding circuit and be insulated from each other. A slot 18 of PCB 11 can be connected to a corresponding protrusion 19 of PCB 13 as shown in FIG. 2.

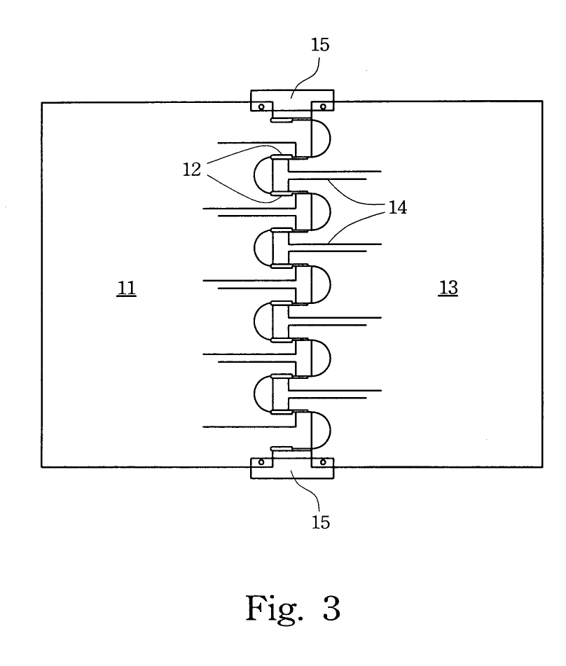

FIG. 3 illustrates a perspective view of 2 PCBs linked by a joint connector according to one preferred embodiment of this invention. One end of a circuit 14 printed on board is electrically connected to the electrical contact 12 while the other end is designed according to system demand.

Referring to FIG. 2 and FIG. 3, a number of the electrical contacts 12 in each slot 18 or a number of the electrical contacts 12 around each protrusion 19 may vary according to system demand. The shape of each slot 18 should compensate for the shape of each corresponding protrusion 19. The shape of the slot 18 or the protrusion 19 is not limited to a square if the slot 18 can properly connect the protrusion 19. For instance, the shape of the slot 18 or the protrusion 19 can be a triangle and the electrical contacts 12 of the slot 18 and the protrusion 19 bond with each other.

In practice, the joint connector is adapted for an interface between high-speed module and low-speed module when the speed of FSB (Font Side Bus) of the system is high, such as FSB is 800 MHz. High speed components, such as CPU, Northbridge Chipset and Graph card, are integrated into a HDI board (illustrated as PCB 11 in FIG. 3) while other components, such as Southbridge Chipset, LAN, I/O circuit and power circuit are integrated in another board (illustrated as PCB 13 in FIG. 3). The joint connector of the present invention is a high-speed interface of good quality.

In addition to connection structure of two boards in the same plane illustrated in FIG. 3, two boards can be connected with any angle, such as 90 degrees (not illustrated in drawings). Moreover, two fastening devices 15 are used to secure firmly the connection between PCB 11 and PCB 13.

The manufacturing method of the joint connector is cutting or punching a connecting rim of a PCB to form a slot of a desired shape. A conductive layer is subsequently deposited in the slot by electroplating. The conductive layer is employed as an electrical contact. After depositing the conductive layer, a circuit layout is printed on a board. Moreover, the conductive layer can be divided into several separate electrical contacts by drilling, cutting or punching insulated gaps within. Thus, the slot can provide more electrical contacts for connection.

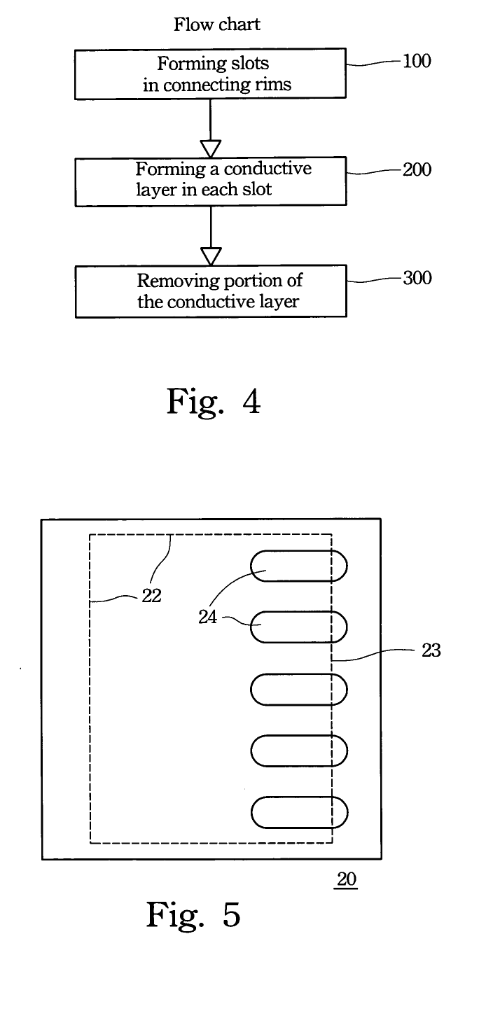

FIG. 4 illustrates a flowchart of manufacturing procedures for a joint connector according to one preferred embodiment of this invention. The manufacturing procedures consist of three main steps. Step 100 is “forming slots in connecting rims”. Step 200 is “forming a conductive layer in each slot”. Step 300 is “removing a portion of the conductive layer”.

FIG. 5 illustrates the first step (step 100 in FIG. 4) of the manufacturing procedures of joint connector according to one preferred embodiment of this invention. The first step is forming slots 24 in a connecting rim 23 of a desired area 22 on a PCB 20 by cutting or punching. A slot 24 can have any shape suitable for connection. In this preferred embodiment of present invention, the slot 24 is square.

Referring to FIG. 5, the PCB with a joint connector (illustrated as PCB 11 or 13 in FIG. 2) is referred to the area 22 of PCB 20 in FIG. 5. The area 22 includes a finished or unfinished circuit printed on or inside.

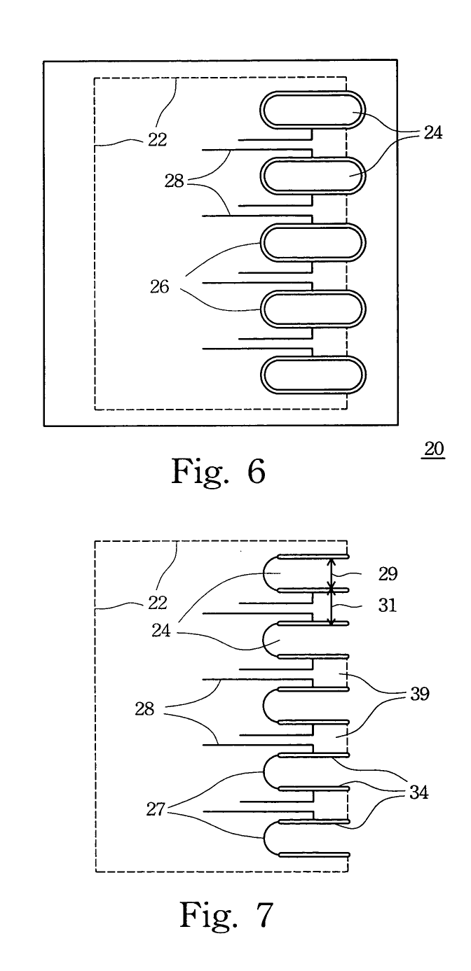

FIG. 6 illustrates the second step (step 200 in FIG. 4) of the manufacturing procedures of joint connector according to one preferred embodiment of this invention. After forming slots 24 in PCB 20, conductive layers 26 are formed in slots 24 to connect circuits 28. The conductive layers 26 can be metal material, such as Cu, Au, Ag, Al, deposited by electroplating.

The conductive layers 26 formed in step 200 are electrically connected to the finished circuits 28 on PCB 20. When no circuits are printed prior to step 200, the circuits 28 need to be printed on PCB 20 to connect with the conductive layers 26.

FIG. 7 illustrates the third step (step 300 in FIG. 4) of the manufacturing procedures of joint connector according to one preferred embodiment of this invention. After forming the conductive layers 26 to connect with circuits 28, step 300 is employed to remove a portion of the conductive layer 26 so as to increase electrical contacts. Namely, step 300 forms insulated gaps 27 between separate electrical contacts. Insulated gaps 27 are formed by cutting or punching a portion of the conductive layers 26.

After insulated gaps 27 are formed, the desired area 22 is cut off from PCB 20 (illustrated in FIG. 5) by cutting or punching. Meanwhile, insulated electrical contacts are formed in the slots 24.

Referring to FIG. 7, a distance 31 between two adjacent electrical contacts in different slots is equal to a distance 29 between two adjacent electrical contacts 34 in the same slot. In other words, a distance 31 between two adjacent slots is equal to an inner width 29 of each slot. Further, a distance 29 between two adjacent protrusions 39 is equal to an inner width 31 of a protrusion 39. A distance 31 between adjacent slots 24 is identical to an inner width 31 of protrusions 39 while a distance 29 between adjacent protrusions 39 is identical to an inner width 29 of a slot 24.

Additionally, an interface length of the joint connector is the thickness of the conductive layer. The thickness may be, for example, 0.1 mm. Thus, the joint connector can avoid noise caused by an impedance mismatch, a parasitic capacitance a parasitic inductance.

The purpose of present invention is to shorten the length of connection interface so as to reduce noise in high-speed communication. High-speed components can be integrated into a small HDI board, rather than all components being integrated into a bigger HDI board. Thus, manufacturing cost can be reduced because an HDI board with small area is used. The joint connector can replace the conventional connector in a low pin-count system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A joint connector for board-to-board communication interface of printed circuit boards, said joint connector comprising:
a plurality of slots, positioned in connecting rims of the printed circuit boards; and
at least one electrical contact, respectively disposed on an inner side of said plurality of slots, wherein the printed circuit boards are connected by assembling two connecting rims of the printed circuit boards and are electrically connected via said electrical contact.

2. The joint connector of claim 1, wherein a distance between two adjacent said slots is equal to an inner width of each said slot.

3. The joint connector of claim 1, wherein said electrical contact is further electrically connected to a circuit on the printed circuit boards.

4. The joint connector of claim 1, further comprising fastening devices positioned at two sides of the connecting rims so as to secure connection.

5. A joint connector for board-to-board communication interface of printed circuit boards, said joint connector comprising:
a plurality of protrusions, positioned in connecting rims of the printed circuit boards; and
at least one electrical contact, respectively disposed in an outer side of said plurality of protrusions, wherein the printed circuit boards are connected by assembling two connecting rims of the printed circuited boards and are electrically connected via said electrical contact.

6. The joint connector of claim 5, wherein a distance between two adjacent said protrusions is equal to a width of said each protrusion.

7. The joint connector of claim 5, wherein said electrical contact is further electrically connected to a circuit on the printed circuit boards.

8. The joint connector of claim 5, further comprising fastening devices positioned at two sides of the connecting rims so as to secure connection.

9. A manufacturing method for a joint connector of printed circuit boards, said manufacturing method comprising:
forming a plurality of slots in connecting rims of the printed circuit boards;
forming a plurality of conductive layers in each of said plurality of slots; and
removing a portion of said conductive layer so as to form an insulated gap, said insulated gap dividing said conductive layer into a plurality of electrical contacts.

10. The manufacturing method of claim 9, wherein said plurality of slots are formed by cutting the connecting rims of the printed circuit boards.

11. The manufacturing method of claim 9, wherein said plurality of slots is formed by punching the connecting rims of the printed circuit boards.

12. The manufacturing method of claim 9, wherein said plurality of electrical contacts are formed by electroplating.

13. The manufacturing method of claim 9, wherein said insulated gap is formed by cutting a portion of said electrical contact.

14. The manufacturing method of claim 9, wherein said insulated gap is formed by punching a portion of said electrical contact.

15. The manufacturing method of claim 9, wherein said insulated gap is formed by drilling a portion of said electrical contact.

16. A manufacturing method for a joint connector of printed circuit boards, said manufacturing method comprising:
forming a plurality of slots and protrusions in connecting rims of the printed circuited boards, wherein each of said plurality of slots is adjacent to each of said plurality of protrusions correspondingly; and
forming a plurality of electrical contacts around outer rims of said plurality of protrusions.

17. The manufacturing method of claim 16, wherein said plurality of protrusions are formed by cutting the connecting rims of the printed circuit boards.

18. The manufacturing method of claim 16, wherein said plurality of protrusions are formed by punching the connecting rims of the printed circuit boards.

19. The manufacturing method of claim 16, further comprising forming a plurality of conductive layers around outer rims of said plurality of protrusions before forming said plurality of electrical contacts.

20. The manufacturing method of claim 19, wherein said plurality of conductive layers are formed by electroplating.

21. The manufacturing method of claim 19, wherein said plurality of electrical contacts are formed by removing portion of said plurality of conductive layers.

22. The manufacturing method of claim 21, wherein said plurality of electrical contacts is formed by cutting portions of said plurality of conductive layers.

23. The manufacturing method of claim 21, wherein said plurality of electrical contacts are formed by punching portions of said plurality of conductive layers.

24. The manufacturing method of claim 21, wherein said plurality of electrical contacts are formed by drilling portions of said plurality of conductive layers.
